(19) United States
(12) Patent Application Publication
(10) Pub. No.: US 2010/0331559 A1
(43) Pub. Date: Dec. 30, 2010

(54) SEPARATION OF NATURAL OIL-DERIVED ALDEHYDES OR HYDROXY METHYL ESTERS USING PROCESS CHROMATOGRAPHY

(75) Inventors: Shawn D. Feist, Midland, MI (US); David R. Albers, Midland, MI (US); Bruce W. Pynnonen, Midland, MI (US); Timothy Charles Frank, Midland, MI (US)

Correspondence Address: The Dow Chemical Company, P.O. BOX 1967, 2040 Dow Center, Midland, MI, 48641, US

(73) Assignee: DOW GLOBAL TECHNOLOGIES INC., Midland, MI (US)

(21) Appl. No.: 12/918,357

(22) PCT Filed: Feb. 6, 2009
(86) PCT No.: PCT/US2009/033326

§ 371 Date: Aug. 19, 2010

Related U.S. Application Data
(60) Provisional application No. 61/030,341, filed on Feb. 21, 2008.

(51) Int. Cl. C11B 3/10; B01D 15/36

(52) U.S. Cl. 554/191

(57) ABSTRACT

Use process chromatographic apparatus and process (for example, SMB chromatographic separation) to effect removal of at least a portion of components that contain neither a hydroxy moiety nor an aldehyde moiety from a feedstream that includes such components as well as components that contain one or more of a hydroxy moiety and an aldehyde moiety.

This application is a non-provisional application claiming priority from the U.S. Provisional Patent Application No. 61/030,341, filed on Feb. 21, 2008, entitled “SEPARATION OF NATURAL OIL-DERIVED ALDEHYDES OR HYROXY METHYL ESTERS USING PROCESS CHROMATOGRAPHY,” the teachings of which are incorporated by reference herein, as if reproduced in full hereinbelow.

This invention relates generally to a process for separating products that result from alkanolysis, hydroformylation and, optionally, hydrogenation of a vegetable oil into usable fractions via process chromatographic separation technology. This invention relates more particularly to a process for separating or removing at least a portion of a first compound that lacks either a hydroxy moiety (for example, methyl stearate and methyl palmitate) or an aldehyde moiety from a mixture that comprises the first compound(s) and at least one second compound, the second compound(s) including at least one of a hydroxy moiety or an aldehyde moiety.

Process chromatographic separation technology includes, without limit, batch separation technology, simulated moving bed (SMB) separation technology and true moving bed (TMB) separation technology. SMB separation technology constitutes a preferred separation technology for purposes of this invention.

Fats and oils, especially vegetable oils, constitute renewable resources for chemical production. The oils and fats contain a distribution of fatty acids tied up as fatty acid glycerides. Subjecting a seed oil or vegetable oil to sequential operations of alkanolysis (for example, methanolysis), hydroformylation and optionally hydrogenation, yields a complex mixture of compounds that lack either a hydroxy moiety or an aldehyde moiety and compounds that contain one or more of a hydroxy moiety or an aldehyde moiety. These compounds have molecular weights that lead to high boiling points (for example, in excess of 150 degrees centigrade (° C.)) and often exhibit small differences in their volatility such that their separation via simple distillation becomes exceedingly difficult, impractical or economically unattractive.

A desire exists for a process that separates such complex mixtures of compounds into fractions that have a high purity (for example, a single component content of greater than or equal (≧) to 90 percent by weight (weight percent), preferably ≧95 weight percent, and more preferably ≧98 weight percent, in each case based upon fraction weight of the two components or groups of components being separated). The desire stems from a belief that such high purity fractions, when used as raw materials for reactions that yield a product such as a polyol, lead to more consistent, and possibly better, product performance parameters than those attainable with the mixture prior to separation.

U.S. Pat. No. 4,189,442 to Lubsen et al. discloses separation of a fatty acid ester mixture according to degree of unsaturation by dissolving the mixture in a solvent to form a solution and contacting the solution with a resin adsorbent, thereby causing the fatty acid ester with the highest degree of unsaturation to be selectively adsorbed on the adsorbent and leaving fatty acid esters with a lower degree of unsaturation in solution. Solvent desorption of the selectively adsorbed fatty acid ester represents a first step in recovering the latter ester from the resin adsorbent. The fatty acid ester mixture results from alcoholysis of naturally occurring triglyceride such as that present in soybean oil, cottonseed oil, safflower oil and tallow.

U.S. Pat. No. 4,495,106 to Cleary et al. presents teachings about separating a fatty acid from a mixture comprising a fatty acid and a rosin acid using a molecular sieve and a displacement material such as an organic acid. Cleary et al. expresses a preference for counter-current moving bed or SMB counter-current flow systems. Cleary et al. refers to, and incorporates by reference, U.S. Pat. No. 2,985,589 to Broughton et al. as it relates to operating principles and sequences of flows of such a system. See also U.S. Pat. No. 4,524,029 to Cleary et al.

U.S. Pat. No. 7,097,770 and its equivalent European Patent Publication (EP) 1,383,854 to Lysenko et al. discuss solid bed adsorptive separation of triglyceride ester mixtures, especially triglyceride ester mixtures derived from plant oils, using an adsorbent with a particle size in excess of 40 micrometers (μm). Adsorbents include silicas, aluminas, silica-aluminas, clays, crystalline porous metallosilicates such as molecular sieves or zeolites, and reticular synthetic polymeric resins such as divinylbenzene cross-linked polystyrenes. The separation requires use of desorbent material (for example, a fluid substance that is capable of removing a selectively adsorbed extract component from the adsorbent). Lysenko et al. notes that one may use a set of two or more static beds, but prefers use of moving bed or SMB systems to effect adsorptive separation. Lysenko et al. describes a pulse test apparatus at column 12, line 57 through column 13, line 18.

U.S. Pat. No. 5,719,302 (Perrut et al.) discloses a process for recovering one or more purified polyunsaturated fatty acids (PUFA(s)) or PUFA mixtures from a feed composition comprising said PUFA(s). The process comprises the steps of: either (i) treating the composition by means either of (a) stationary bed chromatography or (b) multistage countercurrent column fractionation in which the solvent is a fluid at supercritical pressure, and recovering one or more PUFA fractions, and (ii) subjecting the PUFA-enriched fraction(s) recovered in step (i) to further fractionation by means of simulated continuous countercurrent moving bed chromatography and recovering one or more fractions containing purified PUFA or PUFA mixture, or (iii) subjecting a feed composition comprising said PUFA(s) to fractionation by means of simulated continuous countercurrent moving bed chromatography in which there is used as the eluent a fluid at a supercritical pressure, and recovering one or more fractions containing purified PUFA or PUFA mixture.

An aspect of this invention is a process for converting a first mixture that comprises at least one first compound that contains neither a hydroxy moiety nor an aldehyde moiety and at least one second compound that contains at least one of a hydroxy moiety or an aldehyde moiety to a second mixture that has a first compound content that is less than that of the first mixture, said first mixture being produced by subjecting a fat, a seed oil or a vegetable oil to sequential operations of alkanolysis, hydroformylation and, optionally, hydrogenation, the process comprising a chromatographic separation process selected from a group consisting of batch chromatographic separation, true moving bed chromatographic separation, simulated moving bed chromatographic separation and variations or hybrids of one or more of such separations, wherein the first mixture, optionally diluted with a first, or diluting, amount of an elution solvent, and a second, or eluting, amount of elution solvent are fed to the process, the elution solvent being at least one organic solvent selected from a group consisting of aromatic hydrocarbons, nitriles, aliphatic hydrocarbons, aliphatic alcohols, organic acid esters (for example, an acetic acid ester such as ethyl acetate), ethers, and ketones, the process employing at least one column or at least one column segment that is packed with at least one chromatographic medium selected from a group consisting of ion exchange resins, silica gel (more commonly referred to simply as “silica”), alumina, polystyrene-divinylbenzene copolymers (optionally having polymerized therein an additional copolymerizable monomer such as a methacrylate), and crosslinked polymethacrylate, the elution solvent and chromatographic medium combining to effectively remove a substantial portion of the first compound from the first mixture.

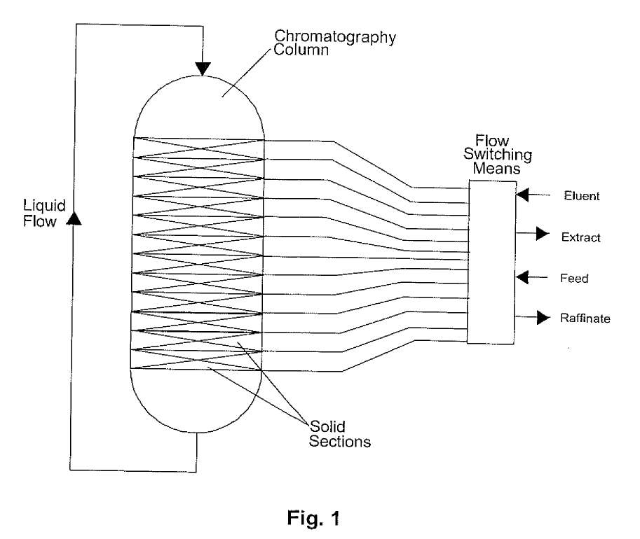

FIG. 1 is a schematic illustration of a single column, multiple section SMB apparatus.

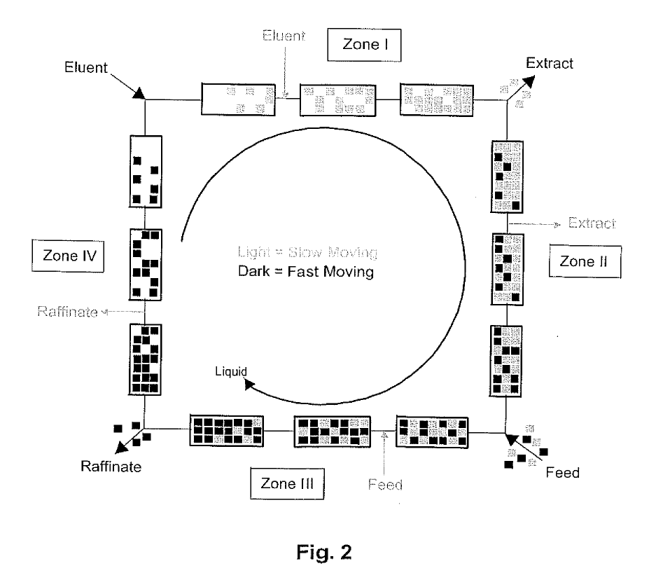

FIG. 2 is a conceptual diagram of a 12-section SMB apparatus with those sections grouped into four equal zones.

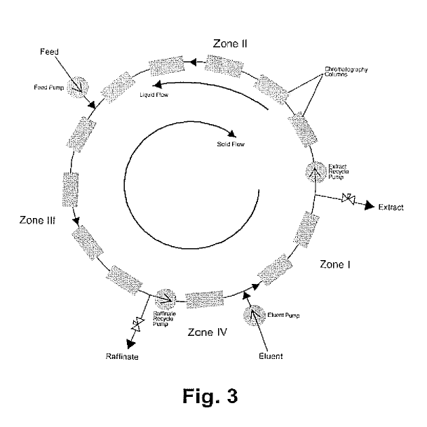

FIG. 3 is a schematic illustration of a SMB carousel implementation.

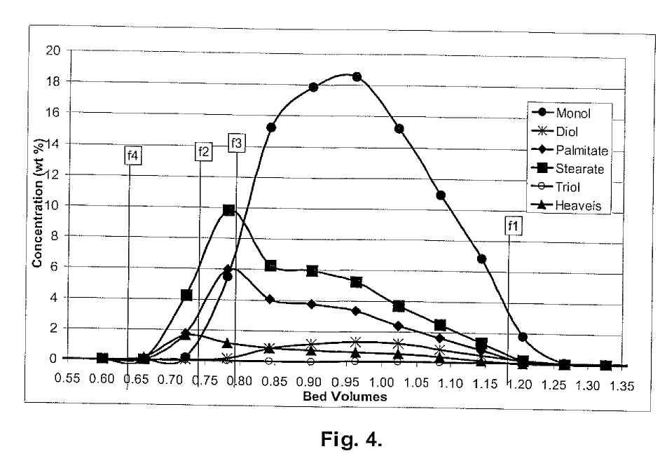

FIG. 4 is a graphic portrayal of pulse test data used to determine initial SMB run parameters for separation of at least one first compound that lacks a hydroxy moiety (for example, palmitate, stearate) from at least one second compound that includes a hydroxy moiety (for example, a monol).

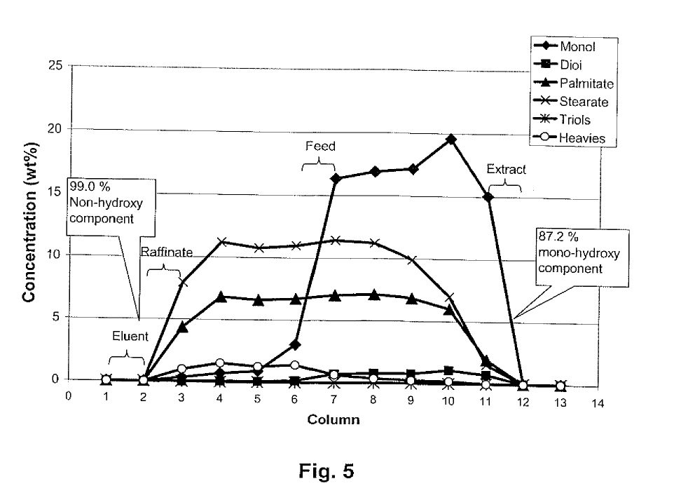

FIG. 5 is a graphic portrayal of a SMB internal concentration profile using a Step Time of 457 seconds.

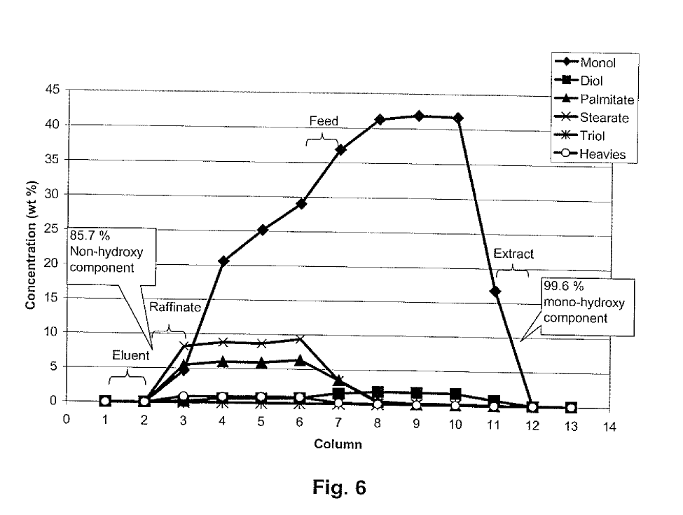

FIG. 6 is a graphic portrayal of a SMB internal concentration profile using a Step Time of eight minutes (480 seconds).

SMB separations in particular and process chromatographic separations in general inherently constitute separations based upon, for example, differences in polarity or differences in size (for example, a molecule and its dimer). SMB separations disclosed herein rely upon differences in polarity such that, as between a first group of molecules and a second group of molecules, one molecule or group of molecules moves through an SMB faster than the other molecule or group of molecules.

Based upon information and belief, SMB separations replicate batch separation performance (as exemplified in “pulse test” or “batch process chromatography” operations), but do so at a reduction in at least one of amounts of separation media, elution solvent, and time and effort used to effect a separation of a given capacity.

SMB separation technology employs an adsorbent or packing medium and an elution solvent to effect separation of a mixture of compounds into fractions or cuts, each of which is rich in a different compound. For example, when the mixture comprises a mixture of a first compound and a second compound, one fraction, nominally a “first fraction”, has a higher concentration of the first compound than the other fraction, nominally a “second fraction”, and the second fraction has a higher concentration of the second compound than the first fraction.

For purposes of this invention, “SMB”, “SMB separation” and “SMB process separation” all refer to the SMB variant of chromatographic process separation technology. The SMB variant itself includes all known variations, subcategories and subsets thereof. A partial, far from complete, listing of such variations includes time-variable SMB (for example, as disclosed in U.S. Pat. No. 5,102,553), ISMB (Improved SMB) (U.S. Pat. No. 4,923,616), split-feed SMB (for example, as disclosed in U.S. Pat. No. 5,122,275), Sequential SMB (SSMB) (U.S. Pat. No. 5,795,398), SMB processes which use fewer columns and may take products out from multiple columns in a loop, but inject feeds into only one column of the loop (U.S. Pat. No. 5,556,546), the Yoritomi process (U.S. Pat. No. 4,267,054), processes with non-simultaneous switching of inlet and outlet positions (U.S. Pat. No. 6,712,973), and the steady state recycling (SSR) or closed-loop recycling with periodic intra-profile injection (CLRPIPI process) (U.S. Pat. No. 5,630,943).

Suitable elution solvents or mixtures of solvents include solvents that a) have a lower boiling point than the fat, vegetable oil or seed oil that yields the mixture of compounds and b) are selected from a group consisting of aromatic hydrocarbons (for example, toluene), nitriles (for example, acetonitrile), aliphatic hydrocarbons (for example, heptane), aliphatic alcohols (for example, ethanol, methanol), organic acid esters (for example, ethyl acetate), ethers (for example, methyl-tert-butyl ether), ketones (for example, methyl isobutyl ketone, acetone), and/or a mixture thereof. Preferred elution solvents include ethyl acetate, acetonitrile, methyl isobutyl ketone, a mixture of an ethanol and a heptane and a mixture of toluene and methanol.

Suitable adsorbent media, sometimes referred to as “chromatographic media,” include those selected from a group consisting of ion exchange resins, silica, silica gel, alumina, polystyrene-divinylbenzene copolymers (for example, DIAION™ HP20 resins, available from Mitsubishi Chemical), and crosslinked polymethacrylate. Preferred adsorbent media include silica gel, alumina, and polystyrene-divinylbenzene copolymers.

The SMB process of the present invention uses polarity differences between different molecules to successfully convert a first mixture that comprises at least one first compound that lacks either a hydroxy moiety or an aldehyde moiety and at least one second compound that contains at least one of a hydroxy moiety and an aldehyde moiety to a second mixture that has a first compound content that is less than that of the first mixture.

In normal phase chromatography (NPC), pack a chromatographic column with a chromatographic medium, typically a porous, polar matrix, such as silica gel, in the form of particles chosen for their physical and chemical stability and inertness, and equilibrate or fill the medium particles with a process solvent, usually less polar in nature than the packed chromatographic medium (also known as “chromatographic packing”).

In reversed-phase chromatography (RPC), pack a chromatographic column with a chromatographic medium, typically a porous, non-polar matrix, such as styrene-divinylbenzene copolymer beads, in the form of particles chosen for their physical and chemical stability and inertness, and equilibrate or fill the medium particles with a process solvent, usually more polar in nature than the packed chromatographic medium (also known as “chromatographic packing”).

In normal-phase chromatography (NPC), the stationary phase (for example, silica) is more polar than the mobile phase (for example, hexane), which results in non-polar compounds being eluted first while polar compounds tend to be retained. RPC uses a non-polar stationary phase (for example, polystyrene divinylbenzene copolymer) and a more polar solvent (for example, methanol). This leads to polar compounds being eluted first concurrent with retention of non-polar compounds.

In either NPC or RPC, the solvent-filled particles constitute a stationary phase. Select the solvent based upon its degree of polarity in order to affect elution time required by the process. The stationary phase is in equilibrium with the liquid outside the particles, which is referred to as the “mobile phase.”

Skilled artisans readily understand adjustments to either normal phase chromatography parameters or reversed-phase chromatography parameters to effect modifications of associated separations. For example, in normal phase chromatography, after the column is packed and equilibrated, add a feed stream to the column. Polar molecules in the feed stream associate with the polar stationary phase and stay longer on the stationary phase relative to the less polar compounds in the feed stream. Adsorption of a specific component on the stationary phase increases with increasing polarity of that specific component. For example, silica gel will retain a fatty acid methyl ester with one hydroxyl group (monol) longer than it will retain a similar compound that lacks a hydroxyl group. Retention time of various molecules being separated can be adjusted through increasing the polarity (to obtain shorter retention times) or decreasing the polarity (to obtain longer retention times) of the mobile phase being used in the separation process.

Batch (or pulse) process chromatography is a conventional method used to separate components via chromatography. In batch process chromatography, pump a feed mixture onto a packed column and use eluent (solvent in chromatographic separation) to push the feed mixture through the column. Different components of the feed mixture separate as they move through the column.

SMB technology, first developed by Universal Oil Products (UOP) in the 1950's, has an industrial application history spanning several decades for separation of petrochemicals, especially xylenes, and fructose/glucose mixtures. In one embodiment of a SMB system, divide the system into four zones whose boundaries are delineated by the four streams entering or exiting the system. In other variations of a SMB system, one may use a greater or lesser number of zones. A SMB process can be described by two basic implementations. The two implementations are either a single column divided into sections as shown in FIG. 1 or a multiple column SMB wherein one groups columns or sections into zones as shown in FIG. 2. One may also use a combination of these two implementations.

The invention may be applied using any process scheme in which the separation is achieved using a chromatography media and solvent. For example, well-known process schemes include batch elution chromatography methods and the 4-zone SMB process scheme described by Philip C. Wankat in “Introduction to Adsorption, Chromatography, and Ion Exchange,” Chapter 17 in Separation Process Engineering, 2nd Ed. (Prentice Hall, Upper Saddle River, N.J.), 2007. Other descriptions of typical 2-zone SMB, 3-zone SMB, and 4-zone SMB process schemes are given by Chim Yong Chin and Nien-Hwa Linda Wang in “Simulated Moving Bed Equipment Designs,” Separation and Purification Reviews, vol. 33, No. 2, pp. 77-155, 2004.

In the single column SMB, divide a large chromatography column into a finite number of small sections. In between these finite sections, use fluid distributors to add, via an inlet, or withdraw, via an outlet, a liquid phase. Simulate SMB counter-current flow by switching positioning of the inlet and the outlet relative to the stationary solid packing inside of the column; by this mechanism, counter-current flow is simulated. In the following description, component refers to a single component or to a group or class of individual components.

As used herein, succeeding paragraphs define four liquid streams: a “Feed” stream, an “Eluent” or “desorbent” stream, an “Extract” stream, and a “Raffinate” stream”.

“Feed” means a stream that enters a SMB system and contains components that are to be separated.

“Eluent” (or “Desorbent”) means a solvent stream that enters a SMB system. The solvent stream contains either a low amount or no amount of Feed or any of its components.

“Extract” refers to a stream that exits a SMB system and contains primarily a slower-moving (more polar in NPC) component of the Feed.

“Raffinate” relates to a stream that exits a SMB system and contains primarily a faster-moving (less polar in NPC) component of the Feed. Faster and slower, as used herein, are relative terms used to differentiate between two components.

As used herein, SMB Zones I-IV have meanings as shown in succeeding paragraphs.

“Zone I” refers to a zone that includes a chromatography column section or group of chromatography columns disposed between an inlet for the Eluent stream and an outlet for the Extract stream.

“Zone II” refers to a zone that includes a chromatography column section or group of chromatography columns disposed between an outlet for the Extract stream and an inlet for the Feed stream.

“Zone III” refers to a zone that includes a chromatography column section or group of chromatography columns disposed between the inlet for the Feed stream and an outlet for the Raffinate stream.

“Zone IV” refers to a zone that includes a chromatography column section or group of chromatography columns disposed between the outlet for the Raffinate stream and the inlet for the Eluent stream.

SMB operations typically include references to two times, “Step Time” and “Cycle Time.” Step Time refers to a time interval between switching of inlet and outlet positions in a SMB loop. Some also refer to Step Time as a time interval or time span between incremental steps or rotation. Cycle Time refers to a time interval required for one complete set of incremental steps, or that time required for a SMB apparatus to return to that position which it occupied at onset of a cycle. Cycle Time equals number of sections or columns in a SMB apparatus multiplied by Step Time.

In the multiple column implementation shown in FIG. 2, one links together in a loop, via piping, all of the SMB columns with the Feed, Eluent, Raffinate, and Extract entering or leaving between various columns in the loop. FIG. 2 shows 12 columns equally distributed in four groups of three columns (each larger box represents a column). The equal distribution of columns is solely for purposes of illustration as skilled artisans recognize that optimal performance of a SMB apparatus may require an unequal distribution of columns, for example, with a greater number of columns in Zones II and III than in Zones I and IV.

A multiple column SMB simulates counter-current flow in one of several ways or implementations. In one implementation, called a “carousel implementation,” packed columns move, while positions of inlet and outlet streams are fixed. A multi-port rotary valve (for example, one of a Knauer design) enables simulation of counter-current flow in this implementation. Irrespective of implementation choice, operating parameters and results from one implementation can easily be translated to another implementation by skilled artisans without undue experimentation.

In FIG. 2, Feed material (Feed), which contains a mixture of the slow and fast component, enters an SMB loop in its lower right hand corner. In FIG. 2, represent the slow component by light shading, the fast component by dark shading, and show the liquid as moving in a clockwise direction. Feed enters a first chromatography column within the continuous loop and the separation of newly added Feed begins. In the column, the fast component moves “forward” at a faster rate than the slow component such that, as between the fast and slow components, more of the fast component enters the next column over (moving clockwise from one column to the next column) than does the slow component. After no more than a minimal amount of the slow component exits the first column, rotate the inlet and outlet positions in the SMB loop one position downstream in the SMB loop. In FIG. 2, stream locations prior to rotation bear black labels and locations post rotation bear grey labels. By properly balancing the liquid flow rates around the feed inlet and the switching of the positions of the inlet and the outlet streams, the fast component moves net “forward” (clockwise) relative to the position of the feed stream, and the slow component moves net “backward” relative to the position of the feed stream.

For proper SMB operation, key features or parameters include a) establishing a proper internal component profile in the four SMB zones as shown in FIG. 2. To establish the proper SMB internal profile, one must determine both the proper time at which the inlet and outlet stream positions switch and a correct flow rate in each of the four SMB zones (multiple columns may exist in each zone). Skilled artisans understand that different flow rates must exist in each zone to prevent the SMB unit from functioning as a diluter. The SMB becomes a diluter if the liquid flow rates in all of the zones are not appropriate. For example, if the flow rate in zone I is too low and the flow rate in zone IV is too high, then the fast moving component continues to move net “forward” (clockwise in FIG. 2) while the slow component continues to move net “backward” (counterclockwise in FIG. 2). Eventually the fast moving component laps the slower moving component and the two components mix together at a lower concentration than in the Feed stream. To prevent the components from lapping each other and to generate an internal profile in which the fast component exits in the Raffinate and the slow component exits in the Extract, the flow rates in each of the zones must be different.

One can determine appropriate initial SMB profile advancement factors (Zone flow rates) by performing a pulse test using the SMB media and the components to be separated. Graph pulse test results as concentration versus bed volumes, where a bed volume equals the volume of the empty chromatography column used to conduct the pulse test. From the pulse test, one can determine a value known as Bed Volumes to Breakthrough (BVTB) for both the slow and fast components. Table 1 below describes choice of profile advancement factors relative to BVTB.

Skilled artisans understand that one typically determines BVTB from a breakthrough curve in either a pulse input experiment or a concentration step-increase experiment. In either of these experiments, compare the front edge of a component profile (as the concentration of the component) to the maximum value which the concentration of the component reaches in the experiment. BVTB equates to the number of column volumes that pass into a column between a starting point of a first inflow of fluid to a step or pulse and ending when one reaches a specified fraction of the maximum value. The specified fraction must be between 0 and 1, with typical fractions of the maximum value being 0.05, 0.10, 0.25, 0.50, 0.75, 0.90, or 0.95.

TABLE 1
Determining SMB Profile Advancement
Factors from Pulse Test BVTB Data

| | Profile | |
|---|---|---|
| SMB | Advancement | |
| Zone | Factor | Description |
| Zone I | Greater than | This will be the largest profile |
| | BVTB_{slow component} | advancement factor. It is high enough |
| | | to force the slow component “forward.” |
| Zone II | Greater than | This is the second lowest profile |
| | BVTB_{fast component} | advancement factor. It is high enough to |
| | | just force the fast component “forward.” |
| Zone | Less than | This is the second highest profile |
| III | BVTB_{slow component} | advancement factor. It is low enough to |
| | | just allow the slow component to move |
| | | “backward.” |
| Zone | Less than | This is the smallest profile advancement |
| IV | BVTB_{fast component} | factor. It is slow enough to force the |
| | | fast component “backward.” |

Unless stated to the contrary, implicit from the context, or customary in the art, all parts and percents are based on weight. For purposes of United States patent practice, the contents of any patent, patent application, or publication referenced herein are hereby incorporated by reference in their entirety (or the equivalent US version thereof is so incorporated by reference) especially with respect to the disclosure of synthetic techniques, definitions (to the extent not inconsistent with any definitions provided herein) and general knowledge in the art.

The term “comprising” and derivatives thereof does not exclude the presence of any additional component, step or procedure, whether or not the same is disclosed herein. In order to avoid any doubt, all compositions claimed herein through use of the term “comprising” may include any additional additive, adjuvant, or compound whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed. The term “or”, unless stated otherwise, refers to the listed members individually as well as in any combination.

Expressions of temperature may be in terms either of degrees Fahrenheit (° F.) together with its equivalent in ° C. or, more typically, simply in ° C.

Sequential operations of alkanolysis (use of methanol or another alkanol to transesterify a triglyceride from a natural oil and produce a fatty acid methyl ester (FAME) plus glycerin); hydroformylation (converting FAME to a mixture of FAMEs that contain anywhere from 0-3 formyl groups per chain); and hydrogenation (converting aldehydes and components of such a mixture that contain a hydroxyl moiety so as to provide a mixture of FAMEs that contain 0-3 hydroxy-methyl groups) yield a mixture of monol, diol, and non-hydroxy components (for example, palmitate or stearate) suitable for, if desired, further processing without separation to produce a polyol suitable for flexible polyurethane foams. The compounds and concentrations listed in Table 2 below typify a soybean oil based reaction mixture obtained at the end of hydroformylation. Exact compositions vary depending on the overall starting FAME material and on the extent of hydroformylation conversion. The compositions in Table 2 illustrate, but do not limit, reaction mixtures or feed materials suitable for treatment by the process of this invention. For example, component composition percentages may vary substantially from one oil to another.

TABLE 2
Typical Mixture of Soy Aldehyde Material in Hydrogenation Feed Material

| | | Approximate |
|---|---|---|
| Component | Representative Structure | Composition |
| Methyl stearate | 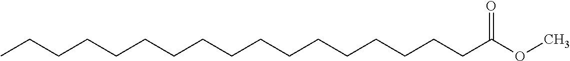 | 5% |
| Methyl palmitate | 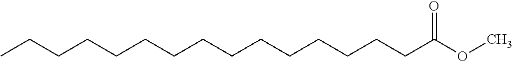 | 10% |
| Methyl oleate | 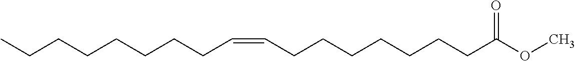 | 8% |
| Methyl linoleate | 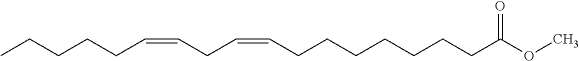 | 4% |
| Methyl linolenate | 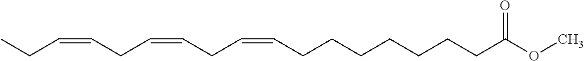 | <1% |
| Monoaldehyde (MA) | 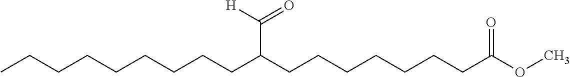 | 39% |
| Dialdehyde (DA) | 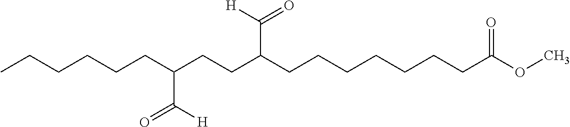 | 33% |
| Trialdehyde (TA) | 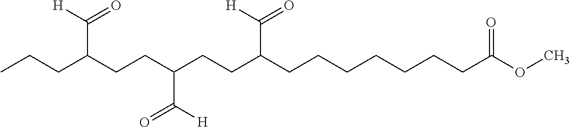 | 3% |

Some of the components in Table 2 are hydrogenated to give components with a hydroxyl moiety. An example of major component classes in the hydrogenated material, at least some of which are present in the Example section of this Application, is shown in Table 3.

TABLE 3
Typical Mixture of Hydrogenated Soy Material

| | | Approximate |
|---|---|---|
| Component | Representative Structure | Composition |
| Methyl stearate | 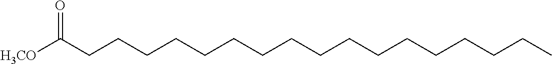 | 19% |
| Methyl palmitate | 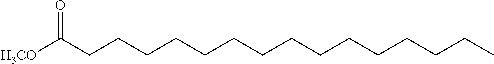 | 11% |
| Mono- hydroxy compound (monols) | 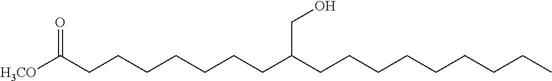 | 38% |
| Di-hydroxy compound (diols) | 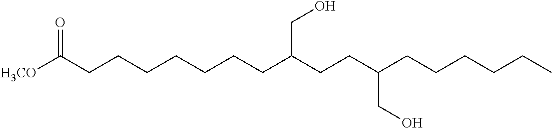 | 27% |
| Tri-hydroxy compound (triols) | 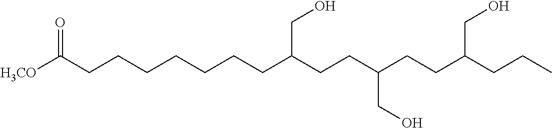 | 2% |
| Heavies | Dimers or linked combinations of the above | 1% |
| Others | | 2% |

Some believe that materials which lack either a hydroxy moiety or an aldehyde moiety (for example, methyl stearate (MS) and methyl palmitate (MP)) provide no advantage, and may even detract from, downstream use of post-hydroformylation or post-hydrogenation mixtures. Accordingly, a desire exists for removal of at least a fraction of such materials prior to such downstream use.

When using a SMB to effect separation in accord with the present invention, one may select from a variety of combinations of solvent and media, some more effective than others. Skilled artisans who work with process chromatographic separation apparatus readily understand use of both solvent and media. For purposes of the present invention, select desirable solvents or mixtures of solvents characterized by a MOSCED polarity parameter, tau (τ), that lies within a range of from 4 to 12 Joules per milliliter (J/mL)^{0.5}, a MOSCED acidity parameter, alpha (α), that lies within a range of from 0 (J/mL)^{0.5} to 6 (J/mL)^{0.5}, and a basicity parameter, beta (β), that lies within a range of from 1 (J/mL)^{0.5} to 12 (J/mL)^{0.5}. The foregoing solvents or mixtures of solvents provide very effective results when used in conjunction with absorbent media selected from silica gel or alumina or ion-exchange beads. See M. L. Lazzaroni et al., “Revision of MOSCED Parameters and Extension to Solid Solubility Calculations”, Ind. Eng. Chem. Res., volume 44 (11), pages 4075-4083 (2005) for a more detailed explanation of τ, α and β.

A combination of ethyl acetate as solvent and silica gel as media provides very satisfactory results when used in conjunction with a process chromatographic separation in accord with the present invention. Other very satisfactory or preferred combinations include acetonitrile as solvent and silica gel as media, methyl isobutyl ketone (MIBK) as solvent and silica gel as media, tetrahydrofuran (THF) as solvent and silica gel as media, methyl tert-butylether (MTBE) as solvent and silica gel as media, a toluene and methanol mixture as solvent and silica gel as media; a mixture of heptane and ethanol as solvent and alumina as media; ethyl acetate as solvent and alumina as media; ethanol as solvent and Diaion™ HP20 adsorbent resin as media; and a mixture of acetonitrile and ethyl acetate as solvent and Diaion™ HP20 adsorbent resin as media. The foregoing combinations represent preferred combinations, but do not constitute an exhaustive list of all possible combinations of solvent and media that may be used with greater or lesser success in terms of effectiveness.

Skilled artisans know that pulse tests are useful in screening activities to evaluate feasibility of SMB applications. See, for example, White, R. N., Mallmann, T. K., Burris, B. D.; “Potential Applications for Industrial Scale Chromatography,” Symposium on Industrial-Scale Chromatography, 211th National Meeting of the American Chemical Society, New Orleans, La., USA, Mar. 28, 1996.

The seed oil derivative may be any of a variety of derivatives including fatty acid esters that contain an aldehyde moiety, fatty acid alkyl esters, hydrogenated fatty alkyl esters, hydroformylated fatty acid alkyl esters or hydroformylated and hydrogenated fatty acid alkyl esters. The seed oil derivative is preferably a hydroformylated and hydrogenated fatty acid alkyl ester or seed oil alcohol derivative. Methyl esters represent a preferred species of alkyl esters for purposes of the present invention.

The seed oil derivative may be prepared from any of a number of plant (for example, vegetable), seed, nut or animal oils including, but not limited to palm oil, palm kernel oil, castor oil, vernonia oil, lesquerella oil, soybean oil, olive oil, peanut oil, rapeseed oil, corn oil, sesame seed oil, cottonseed oil, canola oil, safflower oil, linseed oil, sunflower oil; high oleic oils such as high oleic sunflower oil, high oleic safflower oil, high oleic corn oil, high oleic rapeseed oil, high oleic soybean oil and high oleic cottonseed oil; genetically-modified variations of oils noted in this paragraph, and mixtures thereof. Preferred oils include soybean oil (both natural and genetically-modified), sunflower oil (including high oleic) and canola oil (including high oleic). Soybean oil (whether natural, genetically modified or high oleic) represents an especially preferred seed oil. As between a high oleic oil and its natural oil counterpart (for example, high oleic soybean oil versus soybean oil), the high oleic oil tends to have a simpler, albeit still complex, mixture of components that makes separation of a composition comprising the high oleic oil easier than separation of a composition comprising the natural oil counterpart of the high oleic oil.

Skilled artisans readily understand which temperatures are suitable for process chromatography separations. Preferred temperatures range from −5° C. to 120° C., with temperatures that range from 10° C. to 100° C. being more preferred, and temperatures that range from 15° C. to 80° C. being even more preferred. Skilled artisans also readily understand relative advantages, as between two different temperatures within a range, of operating at a higher temperature or at a lower temperature.

The following examples illustrate, but do not limit, the present invention. All parts and percentages are based upon weight, unless otherwise stated. All temperatures are in ° C. Examples of the present invention are designated by Arabic numerals. Unless otherwise stated herein, “room temperature” and “ambient temperature” are nominally 25° C.

### EXAMPLE 1

Use a pilot-scale or laboratory scale CSEP® model C912 (Knauer GmbH) carousel-style, multi-column (12 stainless steel tubing columns having an inner diameter (I.D.) of 0.43 inch (1.1 centimeter (cm)) and a length of 36 inches (91.4 cm)) SMB apparatus, ethyl acetate (with 0.1 volume percent water) as an Eluent and a 70-230 mesh (63-210 um) silica gel (Fisher Grade 100A, surface area of 375 square meters per gram (m²/g)) as media, to effect separation of non-hydroxy compounds (methyl palmitate or MP and methyl stearate or MS) from remaining mono-hydroxy (monol) and di-hydroxy (diol) components of a Feed stream that has a composition as shown in Table 5 below. Adapt each column for upflow of liquid components through the column. Each column end consists of a ½ inch (1.27 centimeter (cm) OPTI-FLOW™ end-fitting system from Alltech Associates, Inc., each end fitting including a distributor. A ⅛ inch (0.31 cm) tubing fitting welded on each end-fitting enables attachment of the end pieces to a 48-port valve. A 120×400 mesh filter screen (approximate retention size of 40 μm) placed inside of the end fitting prevents media particles from escaping the columns. See FIG. 3 for a schematic illustration of the carousel-style apparatus or implementation.

Mount the 12 chromatography columns onto a rotating carousel housed in a circulated air, heated enclosure operating at a nominal set point temperature of 25° C. The SMB apparatus uses four High Performance Liquid Chromatography (HPLC) pumps, to control the flow rates in each of the four SMB zones (Zones I through IV as detailed above). Skilled artisans readily understand that one may use any of a number of variations of the implementation shown in FIG. 3. One such variation substitutes a flow control valve or another flow controlling device for one or more of the HPLC pumps. See Table 4 below for apportionment of the columns among Zones I through IV. Two of the HPLC pumps supply degassed Feed and Eluent streams into the SMB loop or system. The other two HPLC pumps are piped internal to the SMB loop and serve to recycle portions of the streams leaving Zone I and Zone III. The portions of the streams leaving Zone I and Zone III that are not recycled back into the SMB loop exit the SMB system as the Extract and Raffinate streams, respectively via lines or pipes. Monitor both the external Extract and Raffinate lines with a metering valve to accurately control the amount of material leaving the SMB system. Place sources (for example, vessels) of Feed and Eluent and receptacles for the Extract and Raffinate streams on scales to enable continuous monitoring of inlet and outlet mass flow rates. Before operating the SMB apparatus, calibrate all system pumps (HPLC pumps) with Eluent to ensure accuracy of each pump's digital flow rate display.

Equip the SMB loop with an 8-port, manually-actuated sampling valve. The sampling valve includes two sample loops and allows for one to collect samples of material without introducing air into the SMB loop. The samples of material enable one to determine and understand the internal component concentration profile in the SMB.

For sample analysis via gas chromatography (GC), use a Hewlett Packard Model 5890 GC equipped with J & W Scientific DB-5MS 15 meter (M) by 0.25 millimeter (mm), 0.1 micrometer (μm) film columns

TABLE 4
SMB Zones and Column Numbers

| SMB Zone | Number of Columns |
|---|---|
| Zone I | 2 |
| Zone II | 5 |
| Zone III | 4 |
| Zone IV | 1 |

Table 5 below provides composition information for the Feed stream noted above in this Example 1 and in Example 2. The Feed stream is in admixture with 50 weight percent, based upon total feedstream weight, of ethyl acetate. The Feed stream comprises, in addition to the ethyl acetate, a mixture of hydroformylated and subsequently hydrogenated fatty acid methyl esters (FAMES) derived from soy oil. Table 5 identifies composition components or fractions either specifically, as in methyl palmitate, or generically, as in monols along with weight fractions of each composition component or fraction. The weight fraction sum in Table 5 does not equal 100 percent primarily because approximately 50 weight percent of the feedstream constitutes ethyl acetate and gas chromatographic (GC) analysis that is used to provide the composition fractions does not measure ethyl acetate.

TABLE 5
Feed Stream Composition

| Component | Feed (weight %) |
|---|---|
| FAME C14 | 0.0489 |
| FAME C15 | 0.021 |
| Palmitate | 6.8451 |
| FAME C 17 | 0.077 |
| FAME C 18s | 0.0168 |
| Stearate | 11.51 |
| Monol_Palmitate | 0.0794 |
| FAME C20 | 0.2853 |
| Monoaldehyde | 0.0773 |
| Monol_Stearate | 25.9643 |
| Cyclic Ether | 0.7822 |
| Monol_C20 | 0.1821 |
| Lactols | 0.2205 |
| Diol | 1.2183 |
| Lactones | 0.2466 |
| Triols | 0.2504 |
| Heavies | 2.2398 |
| Total | 50.07 |

Use pulse test data generated with the same Eluent and media as identified above to estimate initial flow parameters for initial operation of the carousel. See FIG. 4 for a graphic portrayal of pulse test data generated with the Feed shown in Table 5 above as well as profile advancement factors f1, f2, f3 and f4. Skilled artisans recognize that initial flow parameters represent estimates only and typically require some adjustment during SMB operation. Determine the profile advancement factors using logic as set forth in Table 1 above. Calculate flow rates for a SMB run based upon the profile advancement factors and an initial feed rate of 0.033 bed volume per hour. With 12 columns, each of which has a volume of 85.67 milliliters (mL), total system volume is 1028 mL and a calculated Feed flow rate is therefore 0.57 mL/minute. Determine profile advancement factor (fᵢ) in accord with formula (1) below:

$${f}_{i} = \frac{Flow rate in Zone i \times Steptime}{Section Volume} \qquad ( 1 )$$

where
fᵢ=profile advancement factor for Zone i
Step time=time between one rotation of inlet and outlet positions
Section Volume=the volume of one section of a SMB zone (for example, 1 column) including
particle and inter-particle volume, that is, simply the empty column volume

By selecting a step time, determining a profile advancement factor (fᵢ) from pulse test data, and knowing section volume, one can calculate a flow rate for each zone. The eluent, extract, raffinate, and feed rate and the flow rates in all the SMB zones are related through mass balances as follows.

Eluent=Flow Rate in Zone I−Flow Rate in Zone IV

Extract=Flow Rate in Zone I−Flow Rate in Zone II

Feed=Flow Rate in Zone III−Flow Rate in Zone II

Raffinate=Flow Rate in Zone III−Flow Rate in Zone IV

One may readily calculate all internal and external SMB flow rates using the above mass balances and the profile advancement factors determined from pulse testing.

Use the logic expressed in Table 1 above to select initial profile advancement factors for separation of non-hydroxy compounds from the Feed stream (Table 5 above). For example, select f4 to prevent non-hydroxy compounds (palmitate and stearate in this instance) contained in the Feed stream from lapping mono-hydroxy compound components of the Feed stream and f1 to prevent monol components from moving forward into a non-hydroxy compound-rich raffinate. Use an initial feed rate of 0.033 bed volumes per hour (BVPH), recognizing that this initial feed rate, while suitable, is solely for purposes of illustration and that other initial feed rates may be used without departing from the spirit or scope of this invention.

For each set of operating parameters, maintain the set of parameters without change until analysis of Extract and Raffinate samples for non-hydroxy compounds and mono-hydroxy compounds reaches a steady state. As used herein, “steady state” refers to samples having non-hydroxy compound and mono-hydroxy compound contents that vary by no more than 10 percent from one sample to a second consecutive sample. Commence sampling and analysis of samples for purposes of determining stream compositions and evaluating effectiveness of operating parameters after reaching steady state conditions.

See Table 6 below for flow rate and profile advancement factor information with a step time of 457 seconds. See FIG. 5 for an internal concentration profile of a non-hydroxy compound/mono-hydroxy compound separation run taken after 24 hours of operation under the conditions listed in Table 6. FIG. 5 shows that while purities are not very high (for example, 87.2 percent by weight (weight percent) for mono-hydroxy compounds and more than 90 weight percent for non-hydroxy compounds, the percentages being based upon combined weight of mono-hydroxy compounds and non-hydroxy compounds), a large portion of non-hydroxy compounds falls back toward the mono-hydroxy compound-rich Extract.

TABLE 6
SMB Zone, Stream Flow Rates and Profile Advancement
Factors for Non-hydroxy Compound/Mono-hydroxy Compound
Separation - 457 Second Step Time

| Zone/Stream | Flow Rate (mL/min) | Profile Advancement Factor |
|---|---|---|
| Zone I | 13.21 | 1.178 |
| Zone II | 8.30 | 0.738 |
| Zone III | 8.87 | 0.789 |
| Zone IV | 7.10 | 0.631 |
| Feed In | 0.57 | Not Applicable |
| Eluent In | 6.15 | Not Applicable |
| Extract Out | 4.95 | Not Applicable |
| Raffinate Out | 1.77 | Not Applicable |

Table 7 below duplicates Feed stream composition from Table 5 above and presents it in combination with Raffinate composition and Extract composition, each in weight percent relative to total weight of, for example, Feed stream when providing weight percent of Feed stream components. In Table 7, components designated as, for example “Frame C14” refer to a fatty acid methyl ester that contains 14 carbon atoms. Listing other components generically, such as diols, lactones, lactols and heavies provides sufficient information to illustrate effective separation via SMB operation.

TABLE 7
Composition of Product Stream - 457
Second Step Time SMB Run of Example 1

| | Feed | Raffinate | Extract |
|---|---|---|---|
| Component | (weight %) | (weight %) | (weight %) |
| Fame C14 | 0.0489 | 0.0063 | 0.0030 |
| Palmitate | 6.8451 | 1.2188 | 0.2686 |
| Fame C17 | 0.0770 | 0.0151 | 0.0021 |
| Stearate | 11.5100 | 2.5363 | 0.2073 |
| Monol_Palmitate | 0.0794 | 0.0022 | 0.0078 |
| Fame C20 | 0.2853 | 0.0562 | 0.0085 |
| Monoaldehyde | 0.0773 | 0.0127 | 0.0024 |
| Monol_Stearate | 25.9643 | 0.0218 | 3.2355 |
| Cyclic Ether | 0.7822 | 0.0500 | 0.0662 |
| Lactols | 0.2205 | Not detected | 0.0346 |
| Diol | 1.2183 | 0.0045 | 0.1066 |
| Lactones | 0.2466 | 0.0095 | 0.0180 |
| Triols | 0.2504 | 0.0069 | 0.0198 |
| Heavies | 2.2398 | 0.5873 | Not detected |
| Total | 50.0650 | 4.5301 | 3.9803 |

Mono-hydroxy compound and non-hydroxy compound cuts from the above separation contain an amount of ethyl acetate solvent. The amount typically ranges from 65 weight percent to 97 weight percent, based upon total cut weight. Skilled artisans understand that use of conventional solvent removal techniques yields, for example, a mono-hydroxy compound cut with a high mono-hydroxy compound content (for example, more than 99 weight percent based upon combined weight of mono-hydroxy compound and non-hydroxy compounds) and a very low solvent content (for example, less than 1 weight percent based upon combined weight of mono-hydroxy compound and non-hydroxy compounds). Such solvent-stripped cuts find use in, for example, flexible foams, rigid foams, elastomers, coatings, adhesives and sealants, lubricants, specialized foam and thermoset applications.

### EXAMPLE 2

Example 2 replicates Example 1 above, except the operating conditions are adjusted to provide for a different Step Time and some different zone flow rates. As an increased purity monol stream has greater commercial potential than an increased purity non-hydroxy compound stream, adjust SMB run parameters to extend the step time from 457 seconds to 480 seconds in an effort to push non-hydroxy compounds forward to the Raffinate and minimize non-hydroxy compound fall back toward the mono-hydroxy compound-rich Extract. See Table 8 below for flow rate and profile advancement factor information with a step time of 480 seconds (eight minutes). See FIG. 6 for an internal concentration profile following the change in step time to 480 seconds.

TABLE 8
SMB Zone, Stream Flow Rates and Profile Advancement
Factors for Non-hydroxy Compound/Mono-hydroxy Compound
Separation - 480 Second Step Time

| Zone/Stream | Flow Rate (mL/min) | Profile Advancement Factor |
|---|---|---|
| Zone I | 12.62 | 1.178 |
| Zone II | 8.29 | 0.774 |
| Zone III | 8.86 | 0.827 |
| Zone IV | 6.72 | 0.628 |
| Feed In | 0.57 | Not Applicable |
| Eluent In | 5.92 | Not Applicable |
| Extract Out | 4.31 | Not Applicable |
| Raffinate Out | 2.14 | Not Applicable |

An examination of FIG. 6 shows that the change in step time to 480 seconds provides a mono-hydroxy compound purity of more than 99 weight percent and a non-hydroxy compound purity of approximately 85.7 weight percent, each weight percent being based upon combined weight of non-hydroxy compounds and mono-hydroxy compounds. The non-hydroxy compound purity suggests that a significant amount of monol (11.0 weight percent) passes to the waste or Raffinate stream. Based upon information and belief, further optimization of run parameters should improve mono-hydroxy compound recovery as reflected by maintaining or improving mono-hydroxy compound purity while improving non-hydroxy compound purity.

TABLE 9
Composition of Feed and Product Streams -
480 Second Step Time SMB Run, Example 2

| | Feed | Raffinate | Extract |
|---|---|---|---|
| Component | (weight %) | (weight %) | (weight %) |
| Fame C14 | 0.0489 | 0.0123 | Not detected |
| Palmitate | 6.8451 | 1.7828 | 0.0041 |
| Fame C17 | 0.0770 | 0.0193 | Not detected |
| Stearate | 11.5100 | 2.9932 | 0.0098 |
| Monol_Palmitate | 0.0794 | 0.0027 | 0.0101 |
| Fame C20 | 0.2853 | 0.0629 | 0.0058 |
| Monoaldehyde | 0.0773 | 0.0248 | Not detected |
| Monol_Stearate | 25.9643 | 0.7578 | 3.1228 |
| Cyclic Ether | 0.7822 | 0.0727 | 0.0036 |
| Lactols | 0.2205 | Not detected | 0.1770 |
| Diol | 1.2183 | 0.0114 | 0.1362 |
| Lactones | 0.2466 | 0.0349 | 0.0101 |
| Triols | 0.2504 | 0.0076 | 0.0105 |
| Heavies | 2.2398 | 0.5752 | Not detected |
| Total | 50.0650 | 6.3888 | 3.5124 |

The data in Table 9 show that one can use SMB to effectively separate non-hydroxy compounds (for example, palmitate and stearate) from the Feed stream as evidenced by the low content of such non-hydroxy compounds in the Extract, relative to hydroxy moiety-containing compounds present in the Extract (predominantly monols and some diol).

What is claimed is:

1. A process for converting a first mixture that comprises at least one first compound that contains neither a hydroxy moiety nor an aldehyde moiety and at least one second compound that contains at least one of a hydroxy moiety or an aldehyde moiety to a second mixture that has a first compound content that is less than that of the first mixture, said first mixture being produced by subjecting a fat, a seed oil or a vegetable oil to sequential operations of alkanolysis, hydroformylation and, optionally, hydrogenation, the process comprising a chromatographic separation process selected from a group consisting of batch chromatographic separation, true moving bed chromatographic separation, simulated moving bed chromatographic separation and variations or hybrids of one or more of such separations, wherein the first mixture, optionally diluted with a first amount of an elution solvent, and a second amount of elution solvent are fed to the process, the elution solvent being at least one organic solvent selected from a group consisting of aromatic hydrocarbons, nitriles, aliphatic hydrocarbons, aliphatic alcohols, organic acid esters, ethers, and ketones, the process employing at least one column or at least one column segment that is packed with at least one chromatographic medium selected from a group consisting of ion exchange resins, silica gel, alumina, polystyrene-divinylbenzene copolymers (optionally having polymerized therein an additional copolymerizable monomer), crosslinked polymethacrylate, the elution solvent and chromatographic medium combining to effectively remove a substantial portion of the first compound from the first mixture.

2. The process of claim 1, wherein the elution solvent has a MOSCED polarity parameter, tau (τ), that lies within a range of from 4 to 12 Joules per milliliter (J/mL)^{0.5}, a MOSCED acidity parameter, alpha (α), that lies within a range of from 0 (J/mL)^{0.5} to 6 (J/mL)^{0.5}, and a basicity parameter, beta (β), that lies within a range of from 1 (J/mL)^{0.5} to 12 (J/mL)^{0.5}.

3. The process of claim 1, wherein the elution solvent is at least one solvent selected from a group consisting of acetonitrile and methyl isobutyl ketone.

4. (canceled)

5. (canceled)

6. The process of claim 1, wherein the chromatographic medium comprises silica gel, alumina, or a polystyrene-divinylbenzene copolymer.

7. The process of claim 1, wherein the process includes hydrogenation and the second compound contains a hydroxy moiety.

8. The process of claim 1, wherein the process excludes hydrogenation and the second compound contains an aldehyde moiety.

9. The process of claim 1, wherein the chromatographic separation process is a simulated moving bed chromatographic separation process.
